(19) United States
(12) Patent Application Publication
(10) Pub. No.: US 2014/0013000 A1
(43) Pub. Date: Jan. 9, 2014

(54) SOCIAL GRAPH BASED PERMISSIONS, PUBLISHING, AND SUBSCRIPTION

(71) Applicants: Vitaly Vainer, Walldorf (DE); Yahali Sherman, Waldorf (DE); Sharon Haver, Walldorf (DE)

(72) Inventors: Vitaly Vainer, Walldorf (DE); Yahali Sherman, Waldorf (DE); Sharon Haver, Walldorf (DE)

(73) Assignee: SAP PORTALS ISRAEL LTD., Ra'anana (IL)

(21) Appl. No.: 13/541,557

(22) Filed: Jul. 3, 2012

(51) Int. Cl. G06F 15/16

(52) U.S. Cl. 709/229

(57) ABSTRACT

Systems and methods for social graph based permissions, publication, and subscription for networks of associations are provided. A role object may be created by a user which can be a member of the network or a visitor who can join or browse the network of associations, defining a network of associations and at least one rule for user access control operation. The server identifies the role object and executes the rules against members belonging to the network of associations. The network of associations may be selected by the user via a social graph. The rules defined by the role object may include setting permissions, publishing, or subscription. Further, the server may automatically set and maintain permissions, publishing audience, and subscription lists in a dynamic network environment.

### TECHNICAL FIELD

This disclosure relates to setting permissions, defining an audience for publishing, and defining user subscriptions, via a graph interface for networks of associations.

### BACKGROUND

Online networks of associations (e.g., social networks, etc.) provide web-based services that allow users of a particular network to connect and interact with other users of the network. A user in the network may choose to share information about himself or herself, or access information of other users. Further, a user may restrict access from other users by manually setting the permission or privacy level. A user may also choose to publish contents to a specific group of audience, or to subscribe information from a specific group of users, by manually setting a named list.

### SUMMARY

The details of one or more embodiments of the disclosure are set forth in the accompanying drawings and the description below. Other features, objects, and advantages will be apparent from the description and drawings, and from the claims.

Aspects of the present disclosure are directed to systems, methods, and computer program products tangibly embodied in a machine-readable storage device for defining and managing networks of relations and rules associated therewith. A role object created by a first user can be received, the role object defining a network of associations and at least one rule, the at least one rule defining access control operations. identifying the network of associations and the at least one rule defined by the role object. It may be determined that a second user is part of the network of associations defined by the role object. The at least one rule can be executed against the second user.

Certain aspects of the disclosure are directed to systems, methods, and computer program products for managing networks of associations. The network of associations can be defined for two or more entities, such as employees, contractors, teams, groups, etc. The entities can share common characteristics or a common relationship, such as a reports to relation. The network of associations can be represented graphically by a graphical structure. A graphical structure can be generated that has nodes that represent the entities and has edges connecting the nodes. The edges can be representative of the relation between two nodes—that is, the edge connects nodes that share a common relationship. The node (and or the relation) can be associated with a role object. The role object defines a rule associated with one or both of the entity associated with the node or the common relationship between the entity and another entity. The rule can include a permission, publishing, or subscribing rule.

In certain aspects of the implementations, the at least one rule includes setting permissions for accessing information associated with the first user to the second user.

In certain aspects of the implementations, the at least one rule includes publishing information associated with the first user to the second user.

In certain aspects of the implementations, the at least one rule includes subscribing, by the first user, for information associated with the second user.

In certain aspects of the implementations, the role object is created by the first user via a social graph including people or business entities.

Certain aspects of the implementations may include receiving a query from the second user.

In certain aspects of the implementations, members of the network of associations defined by the role object vary at different time instances.

Certain aspects of the implementations may include maintaining an updated list of members of the network of associations defined by the role object.

In certain aspects of the implementations, the role object created by the first user is stored in a memory.

In certain aspects of the implementations, the network of associations defined by the role object includes all users that have inter-personal relations.

In certain aspects of the implementations, inter-personal relations include one or both of reporting to a common person or membership of a team associated with a common project.

Certain aspects of the implementations may include associating an edge with a role object, the role object defining a rule associated with the common relationship between connected nodes.

Certain aspects of the implementations may include receiving a request to display information about a node, and graphically displaying the rule associated with one or both of the entity associated with the node or the common relationship between the entity and another entity.

### DESCRIPTION OF DRAWINGS

FIG. 1 is a block diagram of an example system for providing social graph-based permissions, publishing, and subscription.

FIG. 2 is a schematic of an example graph illustrating a network of associations.

FIG. 3 is an example graph illustrating setting permissions via a social graph.

FIG. 4 is an example graph illustrating selecting publishing audiences via a social graph.

FIG. 5 is an example graph illustrating subscribing contents via a social graph.

FIG. 6 is an example process flow diagram for providing social graph based permissions.

FIG. 7 is an alternative example process flow diagram for providing social graph based publishing and subscription.

Like reference symbols in the various drawings indicate like elements.

### DETAILED DESCRIPTION

The present disclosure pertains to providing social graph based permissions, publishing, and subscription for a network of associations (e.g., business networks, social networks, etc.). Setting permissions may include allowing online entities (such as users, administrators, groups, collectives, etc.) to access information of a user. Publishing may include allowing a user to post contents on the web to share with other individuals in the network. Subscription may include allowing a user to listen to messages or information from other individuals in the network. Permissions, publishing audiences, and subscription lists are automatically set and maintained via a social graph interface. It is to be understood that the term social graph is used to represent graphical representations of networks of associations in this disclosure for simplicity. The concepts in this disclosure may apply to various types of representations of networks of associations. The present disclosure may be applied in a business network, social network, small-scale network, or a large-scale, complex network, etc.

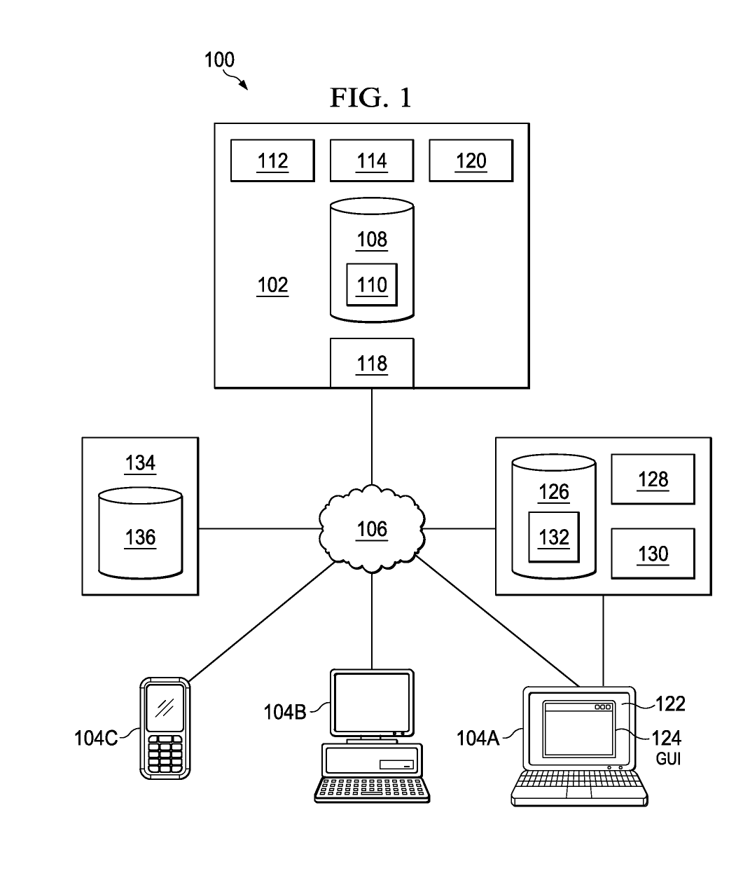

FIG. 1 illustrates an example system 100 for providing social graph based permissions, publishing, and subscription. System 100 includes a server 102, and a client 104A. The server 102 and client 104A communicate across a network 106.

Server 102 includes a processor 120. Processor 120 executes rules defined by the user with respect to user access control operations. Processor 120 can be, for example, a central processing unit (CPU), a blade, an application specific integrated circuit (ASIC), or a field-programmable gate array (FPGA), or other type of processor. Although FIG. 1 illustrates a single processor 120 in server 102, multiple processors may be used according to particular needs, and reference to processor 120 is meant to include multiple processors where applicable. In the illustrated embodiment, processor 120 executes access control module 112 and a rendering engine 114.

Access control module 112 processes the role object defined by users, such as client 104A. A user may be any member of the network or a visitor to the web service who can join or browse the network of associations. An object is a data structure consisting of data fields and methods together with their interactions. The role object defines a network of associations and at least one rule. Rules defined by the role object may be permissions, publishing, or subscription operations with regard to the defined network of associations. The access control module 126 may process queries from other users, such as client 104B, according to the role object defined by client 104A. Further, the access control module 112 may maintain an updated list of members belonging to the network of associations defined by the role object, and automatically execute the rules against all members of the network of associations.

Processor 120 may also execute a rendering engine 114 on the server 102. Rendering engine 114 renders a visualization of large-scale complex networks as a graph that takes into account priority, frequency, relevancy, and group association. The rendering engine 114 makes use of data stored in memory 108 or received across network 106 from, for example, a server 134 associated with social or business networking websites, employers, gaming networks, blogs or other subscription sites, or other locations where information pertaining to network associations is kept. The server 134 may include a memory 136. The rendering engine 114 may keep track of navigation history to enhance the browsing experience throughout different networks, for example, by allowing the user to go back and forth between recently viewed social network representations. The rendering engine 108 may customize the visual representation using provided scores and/or ratings for social entities, hiding/showing specific nodes that will be persisted for future view rendering for the logged-in user, and/or switching between available social network data relevant for the viewed entity.

Server 102 may be any computer or processing device such as a mainframe, a blade server, general-purpose personal computer (PC), Macintosh®, workstation, UNIX-based computer, or any other suitable device. Generally, FIG. 1 provides merely one example of computers that may be used with the disclosure. In other words, the present disclosure contemplates computers other than general purpose computers as well as computers without conventional operating systems. As used in this document, the term “computer” is intended to encompass a personal computer, workstation, network computer, mobile computing device, or any other suitable processing device. For example, although FIG. 1 illustrates one server 102 that may be used with the disclosure, system 100 can be implemented using computers other than servers, as well as a server pool. Server 102 may be adapted to execute any operating system including z/OS, Linux-Intel® or Linux/390, UNIX, Windows® Server, or any other suitable operating system. According to one implementation, server 102 may also include or be communicably coupled with a web server and/or an SMTP server.

Server 102 may also include interface 118 for communicating with other computer systems, such as client 104A, over network 106 in a client-server environment or any other type of distributed environment. In certain implementations, server 102 receives requests for data access from local or remote senders through interface 118 for storage in memory 108 and/or processing by processor 120. Generally, interface 118 comprises logic encoded in software and/or hardware in a suitable combination and operable to communicate with network 106. More specifically, interface 118 may comprise software supporting one or more communication protocols associated with communications network 106 or hardware operable to communicate physical signals.

Memory 108 may include any memory or database module and may take the form of volatile or non-volatile memory including, without limitation, magnetic media, optical media, random access memory (RAM), read-only memory (ROM), removable media, or any other suitable local or remote memory component.

Network 106 facilitates wireless or wireline communication between computer server 102 and any other local or remote computer, such as client 104A. Network 106 may be all or a portion of an enterprise or secured network. In another example, network 106 may be a VPN merely between server 102 and client 104A across a wireline or wireless link. Such an example wireless link may be via 802.11a, 802.11b, 802.11g, 802.11n, 802.20, WiMax, and many others. The wireless link may also be via cellular technologies such as 3GPP GSM, UMTS, LTE, etc. While illustrated as a single or continuous network, network 106 may be logically divided into various sub-nets or virtual networks without departing from the scope of this disclosure, so long as at least portion of network 106 may facilitate communications between senders and recipients of requests and results. In other words, network 106 encompasses any internal and/or external network, networks, sub-network, or combination thereof operable to facilitate communications between various computing components in system 100. Network 106 may communicate, for example, Internet Protocol (IP) packets, Frame Relay frames, Asynchronous Transfer Mode (ATM) cells, voice, video, data, and other suitable information between network addresses. Network 106 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 106 may be a secure network associated with the enterprise and remote client 104A.

System 100 may include multiple users, such as clients 104B and 104C. The server 102 and clients 104A-C communicate across a network 106. System 100 also includes clients 104A-C in communication with server 102 and other servers 134 across network 106.

System 100 allows for a user, such as client 104A, to create a role object 110 defining a network of associations and at least one rule. The role object 110 may be stored in local memory 126 (shown as role object 132), in the server's memory 108, or on a remote and/or distributed memory and retrieved across a network, such as in a cloud-based computing environment. Client 104A may also include a local processor 128 and rendering engine 130.

When a role object is created by client 104A, the role object may be stored at the server 102 as a role object 110. The server 102 may apply the role object 110 (stored in memory 108) to other users of the network, such as clients 104B and 104C. The server 102 may execute the rules defined by the role object against clients 104B and 104C, on the condition that they are validated to be part of the network of associations defined by the role object 110. As a result, if the rules include permission setting and/or publishing, clients 104B and 104C may be able to access information of client 104A. On the other hand, if client 104B or 104C is determined as not being a part of the network of associations, client 104B or 104C would not have the permission to access information of client 104A. Likewise, if the rules include subscription, client 104A may automatically receive all the information or messages clients 104B and 104C post to the network, on the condition that they are validated to be part of the network of associations defined by the role object. Otherwise, client 104A would not automatically receive any information or messages clients 104B and 104C post to the network. Clients 104B and 104C may also create their own roles for the purpose of setting permission to a network of associations, publishing contents to a network of associations, or subscribing contents from a network of associations. Networks of relations between users can be automatically created based on information from, e.g., enterprise information systems, such as Enterprise Resource Planning (EPR), Supplier Relationship Management (SRM), Customer Relationship Management (CRM), etc.

It will be understood that there may be any number of client 104A communicably coupled to server 102. This disclosure contemplates that many clients may use a computer or that one user may use multiple computers to submit or review queries via a graphical user interface. As used in this disclosure, clients may operate remote devices, such as personal computers, touch screen terminals, workstations, network computers, kiosks, wireless data ports, wireless or wireline phones, personal data assistants (PDAs), one or more processors within these or other devices, or any other suitable processing device, to execute operations associated with business applications. For example, client 104A may be a PDA operable to wirelessly connect with an external or unsecured network. In another example, client 104A may comprise laptop that includes an input device, such as a keypad, touch screen, mouse, or other device that can accept information, and an output device that conveys information associated with the operation of server 102 or client 104A, including digital data, visual information, or graphical user interface (GUI) 124. For example, rendering engine 114 may provide a graphic visualization of user profile data, which can be displayed to a user on a display 122 that displays a GUI 124 through which the user can view, manipulate, edit, etc., the graph of user profile data. Both the input device and output device may include fixed or removable storage media such as a magnetic computer disk, CD-ROM, or other suitable media to both receive input from and provide output to users of client 104A through the display 122, namely, over GUI 124.

GUI 124 includes a graphical user interface operable to allow the user of client 104A to interface with at least a portion of system 100 for any suitable purpose, including viewing, manipulating, editing, etc., graphic visualizations of network associations. Generally, GUI 124 provides the user of client 104 with an efficient and user-friendly presentation of data provided by or communicated within system 100. GUI 124 may comprise a plurality of customizable frames or views having interactive fields, pull-down lists, and buttons operated by the user. In one implementation, GUI 124 presents information associated with queries and buttons and receives commands from the user of client 104 via one of the input devices. Moreover, it should be understood that the terms graphical user interface and GUI may be used in the singular or in the plural to describe one or more graphical user interfaces and each of the displays of a particular graphical user interface. Therefore, GUI 124 contemplates any graphical user interface, such as a generic web browser or touch screen, which processes information in system 100 and efficiently presents the results to the user. Server 102 can accept data from client 104A via the web browser (e.g., Microsoft® Internet Explorer or Mozilla® Firefox) and return the appropriate HTML or XML responses using network 106. For example, server 102 may receive a request from client 104A using a web browser or application specific graphical user interface, and then may execute the request to store and/or retrieve information pertaining to user profile data.

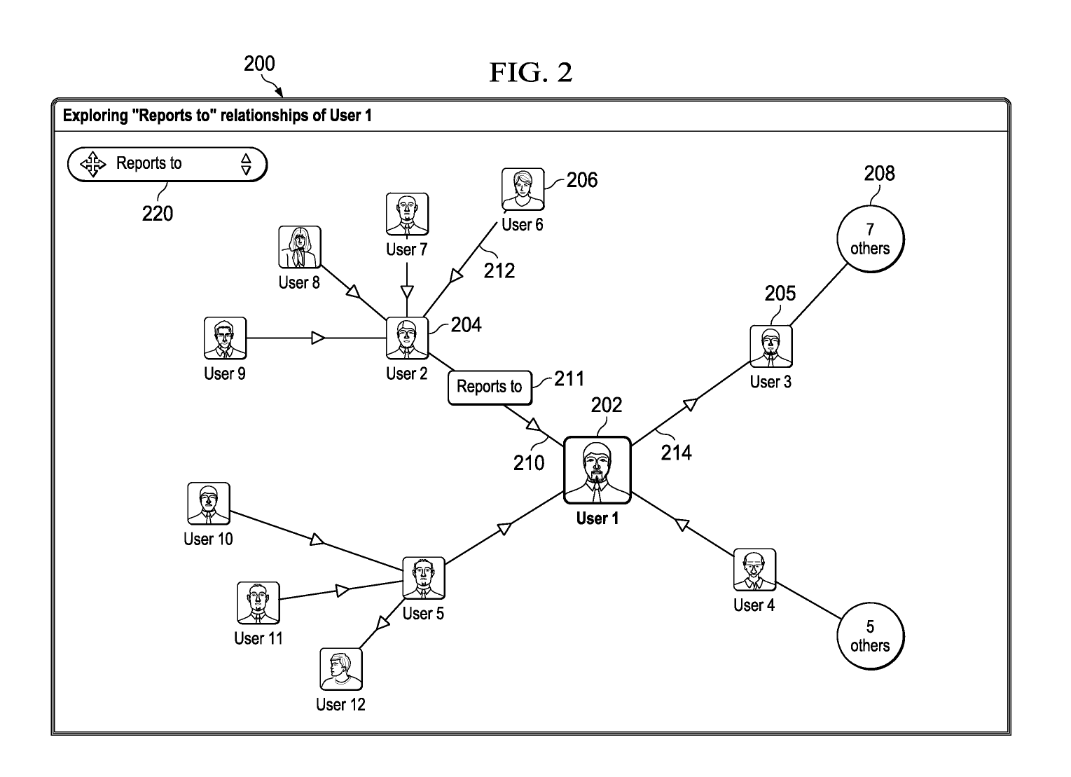

FIG. 2 is a schematic of an example graph 200 illustrating a network of associations. Graph 200 shows a graph of one example association for subject 202. In this case, the GUI provides for a list of associations as a pull-down menu 220, and graph 200 shows the “reports to” associations for subject 202. Subject 202 and his “reports to” associations are shown as an icon with a photograph thumbnail of the associates in this particular example graph. This icon may be chosen by each person or by the owner of the network. For example, an employee ID picture may be used to automatically associate with the icon representing the user. In another example, a user may pick his or her own picture to associate with the icon representing the user. For an icon representing a group, the administrator of the group may select the icon.

The photograph thumbnail icon can be generated by the rendering engine 114, as shown in FIG. 1, from data received from the server storing the information used to generate the graph. The subject 202 and the associates are nodes of the graph, while the associations between the subject 202 and the associates are edges of the graph. The nodes and edges can each vary in size, color, strength (thickness, boldness, etc.), or other visual cues depending on the relevancy, proximity, or other characteristic the associate or association has to the subject 202. Graph nodes represent different entities that are members of the network of associations, and more particularly, nodes that are visualized in any given instance represent entities that fall within the specific network or sub-network the user would like to view. Graph nodes may function differently during design time (or pre-run time) and during run-time (or during visualization of the graph). A node during design time may simply be a holder of data or metadata associated with the entity and its relations. But at run-time, the node may become a visualization (e.g., an interactive visualization) of the entity. In some scenarios, the node itself carries the information required to construct the graph. For example, during design time the node may carry relationship information with other nodes, such as “reports to” information.

As mentioned briefly above, networks of relations between users can be created automatically based on information from enterprise information systems, like ERP, SRM, CRM etc. The “report to” relation may be extracted from ERP Human Resources systems; and “worked on the same project” can be extracted from the project management module of ERP, and “worked on the same customer account” is extracted from CRM system, etc.

Nodes are rendered in different visual cues for representing priority, frequency, relevancy, etc. For example, nodes can be dynamically rendered in different sizes and automatically scaled based on the screen dimensions, while maintaining proportions relative to other nodes for representing importance, priority, relevancy, etc. to the selected relation type(s). Furthermore, the user can “hover” over a node using a mouse pointer or other input interface device. Hovering over a node can reveal information about the node (discussed in more detail later). Nodes can be moved by the user using an input interface device, like a mouse or a finger touch or other input, on the graph interface to view node labels obscured by other nodes.

The example graph 200 graphically represents an organizational chart showing the reporting structure for subject 202. The subject 202 is the largest node, while first tier associates, such as associate 204 and associate 205, are second largest. The second tier of associates, such as associate 206, is third largest, and so on. The tiers, in this case, are based on the proximity to the subject 202 based on the organizational chart. That is, subject 202 is shown to have three immediate subordinates and one immediate superior. Both the subordinates and superiors are shown as the same size, though that can be adjusted based on user preferences. Some second tier associates 206 are also shown. Whether third tier associates are shown is also based on user preferences, and may be based on the available space on the view screen. To that end, certain associates can be clustered together to save space (shown as a clustered node 208). Clustered node 208 can be clustered automatically for nodes deemed less relevant for the selected relation type. In addition, nodes can be selected to manage and/or create rules (e.g., permission, publishing, subscribing) associated with the entity represented by the node.

As shown in FIG. 2, the graph interface allows a user to view and select a network of associations conveniently. Multiple relation types can be selected, such that the graph can show associations for different relation types. For example, the “reports to” relation can be selected, as well as a “same committee membership” relation. The graph would show associates having a “reports to” relationship with subject 202 and associates sharing the same committee membership as subject 202. For this example, data for both sets of relationships can come from the same source; however, the relationships selected for graphing may come from different sources, and the graph would render the associations based on data retrieved from one or more sources. So the “reports to” relation can be selected and a “Facebook® friends” relation can be selected, and the rendering engine 108 would render the graph showing associations for both “reports to” and “Facebook® friends.”

Graph 200 connects associates and subjects using edges, such as edge 210 and edge 214. Different graph edges represent a connection between associates. Edge 210 (also referred to as association 210) has an arrow pointing towards subject 202, thereby indicating “reports to” information—associate 204 reports to subject 202; edge 214 (also referred to as association 214) has an arrow pointing away from subject 202, also conveying “reports to” information—subject 202 reports to associate 205. Second-tier associates are connected to first tier associates by edges as well, such as edge 212, which may exhibit visual characteristics to convey information. The user may “hover” over the edge with a mouse pointer or other interface device, which can display information, such as the relationship or relevancy or other information. For example, hovering over edge 210 displays notation 211, which shows the “reports to” relation between associate 204 and subject 202. In addition, edges can be selected to manage and/or create rules (e.g., permission, publishing, subscribing) associated with the relation represented by the edge.

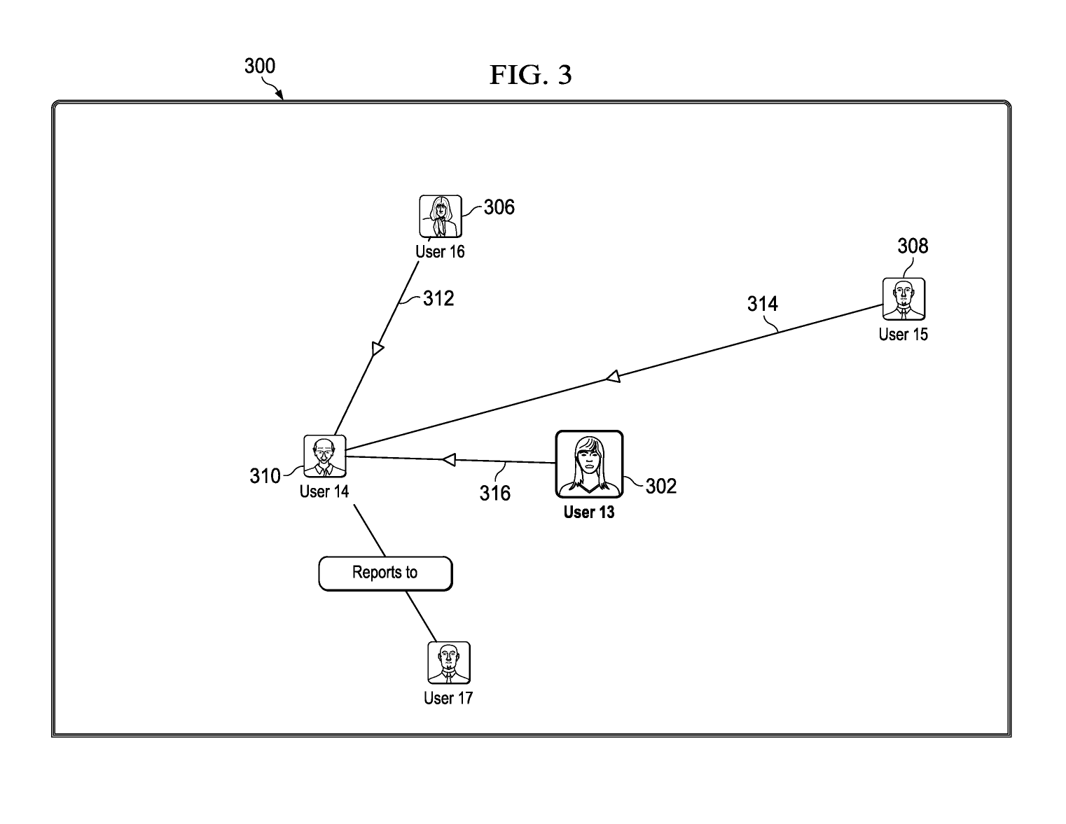

FIG. 3 is an example graph 300 illustrating setting permissions via a social graph. In this example, associate 302 decides to set permissions to her virtual workspace to all employees who report to manager 310. The virtual workspace may be used by business users, such as associate 302, to browse, view, modify, and/or otherwise manipulate data related to the business enterprise. Members reporting to manager 310 constitute a sub-network, and the sub-network is only part of the entire network. Associate 302 then selects this sub-network for permission via social graph 300. Associate 302 would not need to type in names of all entities reporting to manager 310 to set permissions. Rather, associate 302 may select the sub-network of entities reporting to manager 310 easily through the social graph. In the present disclosure, entities may include people, groups, teams, or projects, etc. The social graph 300 may be stored in a local memory 126 (shown in FIG. 1), or on a remote and/or distributed memory and retrieved across a network, such as in a cloud-based computing environment. Accordingly, a new role object, namely role 1, is created and attached to this sub-network. Role 1 defines a sub-network for permission, which includes all users reporting to manager 310. The selected sub-network is also referred to as a network of associations. In addition, role 1 defines a rule for user access control operation, which is to assign viewing permissions for workspace of associate 302 in this example.

In certain implementations, associate 304 may send a query for accessing the workspace of associate 302. The connection 318 between associate 304 and manager 310 is a “reports to” relationship as shown in FIG. 3. Similarly, connection 312 between associate 306 and manager 310, connection 314 between associate 308 and manager 310, and connection 316 between associate 302 and manager 310 are “reports to” relationships in FIG. 3. Server 102 receives the query from associate 304 and checks whether associate 304 is part of the network of associations defined by role 1. Server 102 validates that associate 304 is part of the network of associations defined by role 1 because associate 304 satisfies the condition of reporting to manager 310. Thus, server 102 executes the rule of setting permissions defined by role 1 against associate 304. Consequently, associate 304 is able to access the workspace of associate 302.

The list of members belonging to the network of associations may change whenever a new person joins the network or an existing member leaves the network. For this particular example, if associate 304 later on moves to report to another manager, he would not be able to access the workspace of associate 302 anymore, because he would not be validated as part of the network of associations defined by role 1. Server 102 would not execute the permission rule against associate 304 if he is determined as not being part of the network of associations defined by role 1. Associate 302 would not need to update the permission setting of her workspace even if associate 304 leaves the network. Server 102 would identify that associate 304 does not belong to the network of associations defined by role 1, and automatically update the permission setting with respect to associate 304.

Similarly, associate 308 may move to report to manager 310 at a later time. When this event occurs, server 102 (shown in FIG. 1) would identify that associate 308 becomes part of the network of associations defined by role 1, and execute the permission rule against associate 308. As a result, permissions to access the workspace of associate 302 are automatically updated to allow associate 308 to access the workspace of associate 302. It is not necessary for associate 302 to modify her permission setting to reflect the changes to the network of associations after the role object is created. In other words, the list of members belonging to the sub-network defined by role 1 may be dynamically updated based on the status of users in the network. It is to be understood that the list of members belonging to the sub-network defined by role 1 may still be manually updated by associate 302, in cases that she would like to change the setting in a conventional way.

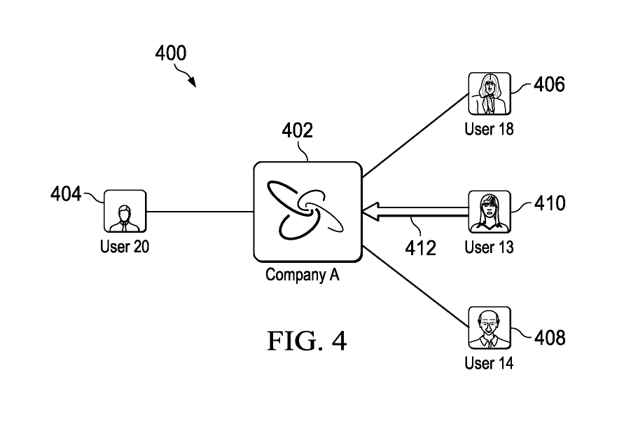

FIG. 4 is an example graph 400 illustrating selecting publishing audiences via a social graph. In this example, associate 410 wishes to publish contents to all members of team 402. Associate 410 then selects this sub-network as publishing audiences via the social graph 400. Accordingly, a new role object, namely role 2, is created and attached to this sub-network. Role 2 defines a sub-network including all members of team 402. In addition, role 2 defines a rule for user access control, which is to publish contents by associate 410 in this example. After role 2 is created, associates 404, 406, and 408 may be able to access the published contents by associate 410. Thus, associate 410 may be able to access team 402 on the level of publishing her information to team 402, as shown by connection 412 between associate 410 and team 402.

Server 102 (shown in FIG. 1) may maintain an updated list of members belonging to the network of associations defined by role 2. Later on if new members join team 402 or existing members leave team 402, role 2 may be automatically updated to reflect the most recent user status. The member list may be updated by the server 102 periodically. Server 102 may also receive notifications when the status of members belonging to the network of associations changes, and then server 102 will initiate a procedure to update the member list.

Associate 410 may also decide to modify the role object by defining a different network of associations or rules. For example, associate 410 may change her mind to publish the contents to entities reporting to associate 404. Then she would only need to modify the selected sub-network to entities reporting to associate 404 in role 2. Or if associate 410 decides to publish the contents to both members of team 402 and entities reporting to associate 404, she would need to modify the selected sub-network by including entities reporting to associate 404 in role 2. The selection and reselection of network of associations may be performed by using the social graph interface. In another example, associate 410 may decide to change the rule of publishing to other user access control operations. Associate 410 would then need to select another rule associated with role 2.

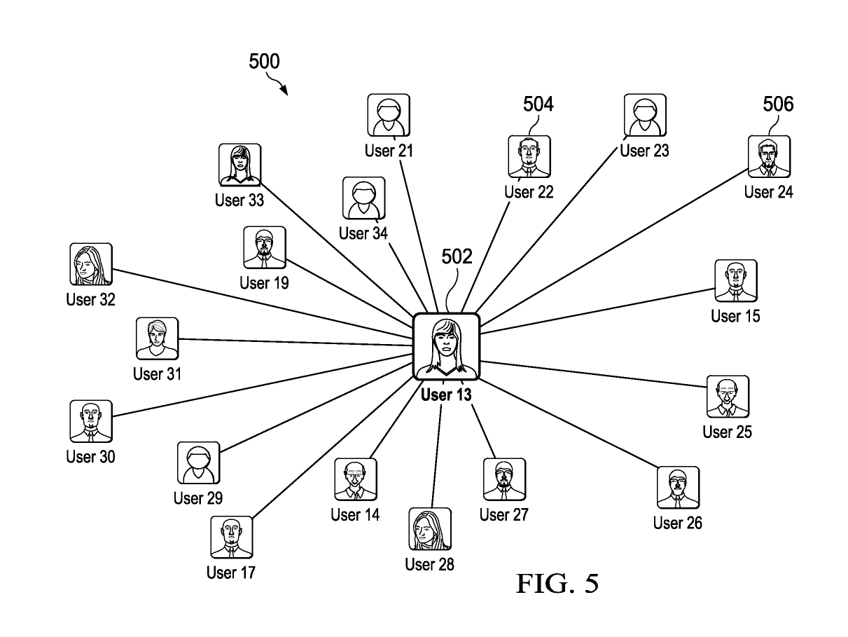

FIG. 5 is an example graph 500 illustrating subscribing contents via a social graph. In this example, associate 502 wishes to subscribe to all collaborators of associate 502, i.e., listen to all collaborators of associate 502. Associate 502 then selects all the collaborators as the network of associations for subscription. Associate 502 would not need to type in names of all her collaborators for subscription. Rather, associate 502 may select the sub-network of all her collaborators easily through the social graph. Accordingly, a new role object, namely role 3, is created and attached to the selected network of associations. Role 3 defines a network of associations including all collaborators of associate 502. In addition, role 3 defines a rule for user access control, which is to subscribe contents from all collaborators of associate 502 in this example. As a result, associate 502 would be notified of any new information posted from her collaborators, such as associates 504 and 506. If the member list of her collaborators changes after role 3 is created, server 102 may update the list of members belonging to the network of associations defined by role 3. Associate 502 would not need to monitor the member status of the selected sub-network, or manually type in the names associated with the updated member list.

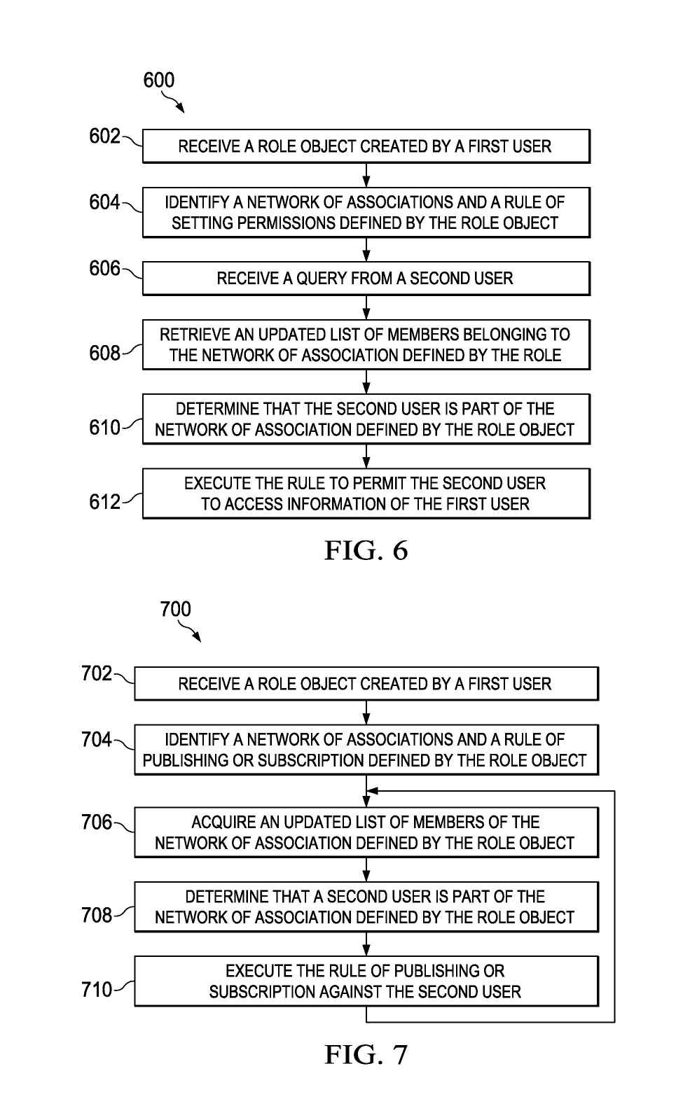

FIG. 6 is an example process flow diagram 600 for providing social graph based permissions. First, a role object created by a first user is received at the server (602). The role object defines a network of associations, such as entities reporting to a certain manager, or all members of a certain team. The network of associations may be selected from a social graph by the first user. The role object also defines at least one rule, such as setting permissions, and the role object may be stored at a memory of the server. The server identifies a network of associations and a rule of setting permission defined by the role object (604). Subsequently, a query directed to the first user is received from a second user at the server (606). The server then retrieves an updated list of members belonging to the network of associations defined by the role (608). The server may determine that the second user is part of the network of associations defined by the role object based on the updated member list (610). In that case, the server would execute the rule to permit the second user to access information of the first user (612). On the other hand, if the second user is determined not as part of the network of associations, the server would not permit the second user to access information of the first user. Steps 606-612 are repeated whenever any new query from the second user or other users is received.

FIG. 7 is an alternative example process flow diagram 700 for providing social graph based publishing and subscription. Similarly, as in flow chart 600, a role object created by a first user is received at the server (702). The role object defines a network of associations and at least one rule, such as publishing or subscription. The server identifies a network of associations and a rule of publishing or subscription defined by the role object (704). As members belonging to the network of associations defined by the role object may change dynamically, the server would maintain an updated member list by periodically checking the member status and updating this list (706). The updated member list may also be maintained by the server receiving a notification whenever a member's status changes and the server updating the list accordingly. The server may determine that a second user is part of the network of associations defined by the role object based on the updated member list (708), and the server would execute the rule of publishing or subscription against the second user (710). After the rule is executed against the second user, the server continues to maintain an updated member list by periodically checking the member status and updating this list. If at a later time the second user is removed from the network of associations defined by the role object, the server will detect the status change of the second user, decide that the second user is not part of the network of associations, and therefore will stop executing the rule of publishing or subscription against the second user. If the network of associations defined by the role object includes multiple users, steps 708-710 are repeated for each user belonging to the network of associations.

A number of embodiments according to the present disclosure have been described. Nevertheless, it will be understood that various modifications may be made without departing from the spirit and scope of the disclosure. Accordingly, other embodiments are within the scope of the following claims.

What is claimed is:

1. A computer implemented method for user access control, comprising:
receiving a role object created by a first user, the role object defining a network of associations and at least one rule, the at least one rule defining access control operations;
identifying the network of associations and the at least one rule defined by the role object;
determining that a second user is part of the network of associations defined by the role object; and
executing the at least one rule against the second user.

2. The method of claim 1, wherein the at least one rule includes setting permissions for accessing information associated with the first user to the second user.

3. The method of claim 1, wherein the at least one rule includes publishing information associated with the first user to the second user.

4. The method of claim 1, wherein the at least one rule includes subscribing, by the first user, for information associated with the second user.

5. The method of claim 1, wherein the role object is created by the first user via a social graph including people or business entities.

6. The method of claim 1, further comprising receiving a query from the second user.

7. The method of claim 1, wherein members of the network of associations defined by the role object vary at different time instances.

8. The method of claim 7, further comprising maintaining an updated list of members of the network of associations defined by the role object.

9. The method of claim 1, wherein the role object created by the first user is stored in a memory.

10. The method of claim 1, wherein members of the network of associations defined by the role object includes all users that have inter-personal relations.

11. The method of claim 10, wherein inter-personal relations include one or both of reporting to a common person or membership of a team associated with a common project.

12. A computer program product, tangibly embodied in a machine-readable storage device, the computer program product being operable to cause data processing apparatus to perform operations comprising:
receiving a role object created by a first user, the role object defining a network of associations and at least one rule, the at least one rule defining access control operations;
identifying the network of associations and the at least one rule defined by the role object;
determining that a second user is part of the network of associations defined by the role object; and
executing the at least one rule against the second user.

13. The product of claim 12, wherein the at least one rule includes setting permissions for accessing information associated with the first user to the second user.

14. The product of claim 12, wherein the at least one rule includes publishing information associated with the first user to the second user.

15. The product of claim 12, wherein the at least one rule includes subscribing, by the first user, for information associated with the second user.

16. The product of claim 12, wherein the role object is created by the first user via a social graph including people or business entities.

17. The product of claim 12, further comprising receiving a query from the second user.

18. The product of claim 12, wherein members of the network of associations defined by the role object vary at different time instances.

19. The product of claim 18, further comprising maintaining an updated list of members of the network of associations defined by the role object.

20. The product of claim 12, wherein the role object created by the first user is stored in a memory.

21. The product of claim 12, wherein the network of associations defined by the role object includes all users that have inter-personal relations.

22. The method of claim 21, wherein inter-personal relations include one or both of reporting to a common person or membership of a team associated with a common project.

23. A method for managing networks of associations comprising:
identifying two or more entities that share a common relationship;
generating a graphical structure having nodes that represent the entities and having edges connecting the nodes, the edges representative of the common relationship shared by the two or more entities;
associating the node with a role object, the role object defining a rule associated with one or both of the entity associated with the node or the common relationship between the entity and another entity; and
displaying the graph structure.

24. The method of claim 23, further comprising associating an edge with a role object, the role object defining a rule associated with the common relationship between connected nodes.

25. The method of claim 23, further comprising receiving a request to display information about a node, and graphically displaying the rule associated with one or both of the entity associated with the node or the common relationship between the entity and another entity.
